(19) United States
(12) Patent Application Publication
(10) Pub. No.: US 2026/0290209 A1
(43) Pub. Date: Sep. 24, 2026

(54) INSCRIBABLE LABEL WITH HOLDING BRACKET CONNECTED THERETO

(71) Applicant: Phoenix Contact GmbH & Co. KG, Blomberg (DE)

(72) Inventors: Thomas PÖLKER, Horn Bad-Meinberg (DE); Rüdiger HARNASCH, Paderborn (DE); Axel HAUSMANN, Horn Bad-Meinberg (DE); Karsten FRISCHEMEIER, Lügde/Niese (DE)

(21) Appl. No.: 19/162,060

(22) PCT Filed: Mar. 13, 2024
(86) PCT No.: PCT/EP2024/056651

§ 371 Date: Sep. 4, 2025

(30) Foreign Application Priority Data
Mar. 16, 2023 (BE) BE2023/5194

(51) Int. Cl. G09F 3/06; G09F 3/02

(52) U.S. Cl. CPC G09F 3/06; G09F 3/02

(57) ABSTRACT

An inscribable label (1A) for attachment to a cable grommet comprises: a label portion (10) with an inscribable label surface (100), a locking element (11A) connected to the label portion (10) and a holding bracket (12A) on which a locking portion (13A) is formed for locking with the locking portion (11A).

### CROSS-REFERENCE TO PRIOR APPLICATIONS

This application is a U.S. National Phase application under 35 U.S.C. § 371 of International Application No. PCT/EP2024/056651, filed on Mar. 13, 2024, and claims benefit to Belgian Patent Application No. BE2023/5194, filed on Mar. 16, 2023. The International Application was published in German on Sep. 19, 2024 as WO/2024/189070 under PCT Article 21(2).

### FIELD

The invention relates to an inscribable label, a label sheet and an inscribable label set.

### BACKGROUND

Inscribable labels are regularly used to label cables and the like. In general, it is desirable for them to be as simple to handle as possible. Because such inscribable labels are often required in very large quantities, it is particularly advantageous to make them as simple as possible to produce.

Often, inscribable labels are attached to a grommet, e.g., a cable grommet, which in turn is mounted on a line, e.g. a cable, hose or the like. In many cases, this allows for particularly quick and simple attachment of inscribable labels.

EP 0 416 170 A1 describes an inscribable label that is clamped in a grommet channel of a cable grommet. A narrow tab is provided for inserting the inscribable label into the feed-through. The disadvantage of this solution is that an inscribable label surface is arranged inside the cable grommet, which makes it difficult to see the applied inscription and requires a cable grommet material that is as transparent as possible. Furthermore, the size of the label surface is limited, which severely restricts the amount of information that can be applied thereto.

DE 10 2020 108 845 A1 describes a solution that eliminates the disadvantages mentioned above. Accordingly, an insertion arm is moved against a stop for the grommet and comes to rest there in a non-deflected state. However, it has been shown that the inscribable label can very easily be accidentally detached from the cable grommet. In addition, production using the injection molding process is only possible with great effort due to long flow paths, in particular if a plurality of inscribable labels are to be produced in one integral unit. This puts a strain on production time and the complexity of the tools required for production.

### SUMMARY

In an embodiment, the present invention provides an inscribable label for attachment to a cable grommet, the inscribable label comprising: a label portion with an inscribable label surface; a locking device connected to the label portion; and a holding bracket, wherein a locking portion is formed on the holding bracket, the locking portion being configured for locking with the locking device.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIGS. 1A and 1B show a label sheet with a plurality of inscribable labels;

FIGS. 2A and 2B show an inscribable label of the label sheet according to FIGS. 1A and 1B with a label portion, a locking device and a holding bracket in an initial configuration;

FIGS. 3A-3D show the inscribable label according to FIGS. 2A and 2B in a locked configuration;

FIGS. 4A and 4B show the inscribable label according to FIG. 2A to 3D in a configuration in which it is locked to a cable grommet;

FIG. 5 show an inscribable label with a label portion, a locking device and a holding bracket;

FIGS. 6A and 6B show two inscribable labels locked together according to FIG. 5;

FIG. 7 shows an inscribable label with a label portion and two holding brackets in an initial configuration;

FIG. 8 shows the inscribable label according to FIG. 7 in a locked configuration;

FIG. 9 shows the inscribable label according to FIGS. 7 and 8 in a configuration in which it is locked to a cable grommet;

FIG. 10 the inscribable label according to FIG. 2A to 4B with an optional safety pawl; and

FIGS. 11A, 11B, 12, 13 and 14 further inscribable labels, each with a label portion and a holding bracket.

### DETAILED DESCRIPTION

In an embodiment, the present invention provides an improved inscribable label that can be produced simply and inexpensively.

In an embodiment, the present invention provides an inscribable label for attachment to a cable grommet is provided, comprising a label portion with an inscribable, e.g. printable, label surface, a locking device connected to the label portion, and a holding bracket on which a locking portion is formed for locking with the locking device.

This makes handling particularly simple, as, for example, the holding bracket can simply be pushed into a cable grommet, and the label portion can be folded over at the film hinge and locked with the holding bracket. Using the locking device, the free end of the holding bracket can be held in a locked state on the label portion in such a way that its movement is limited in (at least) two mutually orthogonal directions. The holding bracket is not only secured laterally, but also, for example, against movement along its extension direction. This is achieved using locking means. Overall, the holding bracket can be secured in the end position in three spatial directions (in particular “back,” “right” and “down,” in each case relative to the label surface) and in the remaining spatial directions, for example, at least to a limited extent.

It can be provided that the holding bracket is connected to the label portion so that it can move relative to the label portion (in particular via a material thinning, e.g., via a film hinge). Such a material thinning can form a joint that allows a pivoting movement of the holding bracket relative to the label surface in two axes (or in the form of a hinge about one axis). The embodiment as a film hinge allows for pivoting, the elastic material of the inscribable label also allowing lateral freedom of movement in order to thread the holding bracket into the locking device. In this way, the geometric design and the material elasticity can work together collusively to allow for corresponding 3D movement. The film hinge allows for relatively high mobility of the holding bracket about a pivot axis relative to the label portion, which in turn ensures freedom in production. A plurality of inscribable labels can be arranged along a common plane. This is achieved in that the holding bracket is arrangeable accordingly and, after detachment, also deflectable relative to the assembly. For example, a plurality of labels can be produced in one coherent unit in a simple manner. The inscribable label can be made in one piece of uniform material. The film hinge can be realized by a portion that is thinner compared to adjacent portions. Furthermore, the film hinge can prevent torsion of the holding bracket.

The label portion and the holding bracket can extend in one plane in an initial position. In a mounting position, the holding bracket can be aligned at an angle to the label portion. In a securing position, the holding bracket can be arranged parallel to the label portion. This means that a plurality of such inscribable labels can be produced together in one sheet, so that a plurality of inscribable labels can be printed on at the same time in one printer. Instead of or in addition to printing, an inscription can also be applied by embossing or by means of laser radiation by changing the contrast on the marking surface or by attaching a label. The label/inscription can be applied in one operation.

The film hinge is connected to the label portion, for example, at a free end and/or at a side edge of the label portion, e.g., a side edge bordering the label surface. This allows for a flat design and particularly simple handling.

The locking portion of the holding bracket cooperates with the locking device to prevent release in a rest position in which the holding bracket is mounted in the locking device, which functions as a lock, for example. For this purpose, for example and in particular, a recess is provided, preferably at one end. Preferably, the free end of the holding bracket is hook-shaped. The locking portion of the holding bracket can therefore be hook-shaped, for example, or alternatively be in the form of an eyelet. This allows for simple and secure locking.

The locking device, for example, ensures that the holding bracket is supported. The holding bracket can therefore, for example, be supported on one side via the connection to the label portion and on the other side by the locking device acting as a counter-support to receive a portion at the free end of the holding bracket. Optionally, the locking device has a pocket. For example, the locking portion of the holding bracket can be inserted into the pocket. This allows for particularly secure locking such that the holding bracket cannot be pulled out of the locking device.

The pocket can have an L-shaped or T-shaped opening. This allows straight insertion and simple locking with the hook-shaped locking portion, for example. Alternatively or additionally, a receptacle for the holding bracket can be L-shaped or T-shaped, e.g., so that a three-sided enclosure and/or support is formed, one side of which is provided with an insertion opening for the holding bracket. In addition, a mount can be added in the direction of extension of the label portion in order to form a stop.

In one embodiment, the locking device has two side walls. The side walls can be connected to one another by a bottom. This allows for a particularly high level of stability of the locking device and thus a secure locking mechanism that is not prone to accidental opening. Furthermore, it is possible to stiffen even an elastic material in order to create the desired mounting and generate the closing action. Three side walls can also be connected to the bottom, of which, for example, at least two extend in the direction of the label portion and are preferably connected thereto.

The locking device can be arranged, in particular protrude, at least in portions, below the label portion. For example, the locking device is formed on a rear side of the label portion. The locking device can be formed on a rear side of the label portion opposite the label surface. This allows a particularly large label surface to be provided, the locking device not being visible after the inscribable label has been attached. This allows for a clearer overall picture, in particular when a large number of inscribable labels are installed next to one another. This clarity is an advantage when it comes to handling. However, a planar extension also allows for simpler manufacturing, as the necessary tools can be designed more simply. In addition, the resulting stackability offers storage advantages as well as advantages during the inscription process in a printer.

The locking portion of the holding bracket can be inserted into the locking device along an engagement direction and, optionally, can be locked in the locking device with the locking device in a locking direction perpendicular to the engagement direction. This allows for intuitive yet secure locking. The longitudinal extension in an initial position also allows for simple handling during threading, since the holding bracket is visible and the label surface also allows good orientation of the holding bracket. The mobility of the free end of the holding bracket can be fixed in the end position in at least three directions, preferably in all spatial axes (x, y, z) relative to the label portion. An optional release mechanism is provided for non-destructive release of the movement lock.

The holding bracket and/or the label portion can be elongated and have a longitudinal extension direction. The engagement direction can be parallel (or perpendicular) to the longitudinal extension direction. This allows for simple and intuitive locking even with small dimensions of the inscribable label.

The holding bracket is optionally designed to be elongated. The holding bracket extends, for example, between an end pivotably mounted and/or connected to the label portion, to a free end and is in particular rod-, arm-or bar-shaped, preferably cylindrical. The holding bracket is more rigid than the film hinge. The locking portion of the holding bracket can have a lateral recess. This allows for secure locking and simple production.

The locking device can provide a mounting for the portion of the free end of the holding bracket, which is held there in a locking manner. Optionally, the locking device has a recess for this purpose. It can be provided that the locking portion can be locked to the locking device in such a way that the recesses engage with one another, in particular are aligned perpendicular to one another. In this way, a locking mechanism that is simple to close can be achieved using particularly simple means.

In other words, the locking device can provide a locking mechanism having a locking option. Here, the free ends are shaped by way of example according to a lock-and-key principle, therefore formed complementarily to hold one another. is designed in one embodiment on a further holding bracket, which, for example, is connected to the label portion via a further film hinge so as to be movable relative thereto. This allows a particularly low-profile structure to be achieved that can be produced by injection molding using a simple open-and-close mold without sliders, and that can be shipped in a particularly compact, stacked form.

The holding bracket and the further holding bracket can be connected to the label portion on opposite sides of the label portion, in particular integrally, preferably in a cohesively bonded manner, most preferably monolithically. This allows for a locking mechanism that can be assembled by hand with ease.

The locking device can have a recess that is, for example, hook-shaped or in the form of an eyelet. This allows for a particularly simple structure.

According to one aspect, a label sheet is provided, comprising a plurality of inscribable labels (e.g., inscribable labels that can be separated from an assembly, in particular without tools, e.g., broken out), each of which can be designed according to any embodiment described herein. This means that a plurality of inscribable labels can be produced and printed on at once.

According to one aspect, an inscribable label set is provided, comprising an inscribable label according to any embodiment described herein and a grommet (e.g., a cable grommet) having a bracket feed-through for engagement by the holding bracket. As regards the advantages, reference is made to the above statements.

The grommet (e.g., cable grommet) can have a feed-through (in particular a line or cable feed-through) for passing through a line (e.g., a supply line, transport line or the like), in particular a cable, hose (e.g., pneumatic hose), pipe or rod, or generally a cylindrical body or hollow body. This allows for simple and secure installation on the body in question, e.g., on the cable.

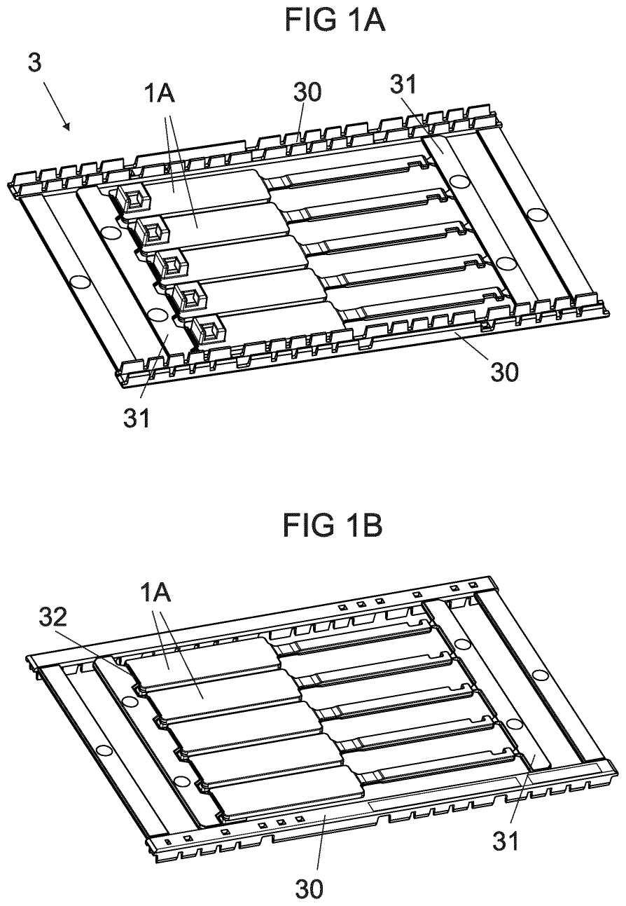

FIGS. 1A and 1B show a label sheet 3 having a plurality of inscribable labels 1A. The inscribable labels 1A can each be separated from the rest of the label sheet 3; in this case, they can be easily broken out without tools. The label sheet 3 comprises two parallel side webs 30 that are connected to one another by a plurality of, in this case four, transverse webs 31. The inscribable labels extend between the transverse webs 31.

The label sheet 3 is formed integrally, in this case from a plastics material. The label sheet 3 is an injection-molded part that was manufactured in a plastics injection molding process.

The inscribable labels 1A can be printed on, for example using a printer, and can also be written on by hand with a pen if required. On the one hand, it is possible to separate individual inscribable labels 1A from the rest of the label sheet 3 and then to print on or label them or to mark them in some other way. On the other hand, the label sheet 3 can also be fed to a printer as a whole, so that a plurality of or all of the inscribable labels 1A can be printed on in a single operation. For this purpose, the side webs 30 in the example shown are designed in the form of runners that can be guided on a transport device of the printer. As can be seen in particular from FIG. 1B, surfaces of the inscribable labels 1A in the label sheet 3 lie in one plane (in particular the label surfaces 100 explained in more detail below), so that they are inscribable using the same inscription means.

Predetermined breaking points at the transitions between the inscribable labels 1A and the other portions of the label sheet 3, in this case the transverse webs 31, allow easier separation of the individual inscribable labels 1A.

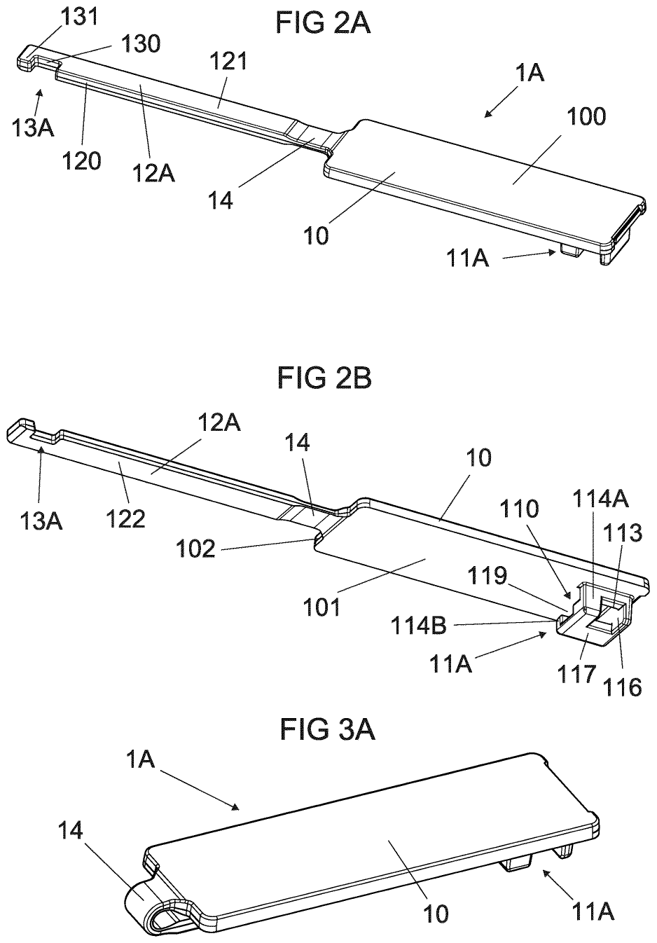

FIGS. 2A and 2B show one of the inscribable labels 1A of the label sheet 3 after separation therefrom, but it should be noted that it would also be possible to produce such inscribable labels 1A individually, i.e., not in a label sheet 3.

The inscribable label 1A comprises a label portion 10 having a label surface 100. The label portion 10 is flat and elongated. The label portion 10 is designed in the form of an elongated plate. The label surface 100 is inscribable, meaning that writing, a color marking and/or other markings can be applied or incorporated (attached, arranged) thereon. The label surface 100 is flat, i.e., it runs in a plane spanned by two straight lines.

The inscribable label 1A further comprises a locking device 11A. The locking device 11A is connected to the label portion 10, more precisely, firmly connected thereto. In the example shown, the locking device 11A is formed on the label portion 10. The locking device 11A protrudes from the label portion 10 on a rear side 101 of the label portion 10. The rear side 101 of the label portion 10 represents the side opposite the label surface 100 and, in the example shown, has the same external shape as the label surface 100. As can be seen in particular from FIG. 2B, the locking device 11A is arranged at a longitudinal end of the label portion 10. The locking device 11A is cuboid-shaped. The locking device 11A forms an interior space in the form of a pocket 110. The pocket 110 is defined by side walls 114A, 114B, a rear wall 116, a bottom 117 and a region of the label portion 10. The rear wall 116 faces a longitudinal end of the label portion 10 (and is arranged adjacent thereto). The bottom 117 runs (substantially) parallel to the label portion 10. The side walls 114A, 114B run parallel to one another (apart from draft angles, if any are formed).

A window 113 is formed in one of the side walls 114A and in the bottom 117. Opposite the rear wall 116, an opening 119 is provided through which the pocket 110 is accessible.

Furthermore, the inscribable label 1A comprises a holding bracket 12A. A locking portion 13A designed for locking with the locking device 11A is provided on the holding bracket 12A. The holding bracket 12A is movably connected to the label portion 10 via a single-joint or multi-joint hinge, in this case via a single-joint hinge. In this case, a material thinning is provided, which material thinning forms the hinge. In the example shown, a film hinge 14 is specifically provided, via which the holding bracket 12A is connected to the label portion 10 so that it is movable relative to the label portion 10. The film hinge 14 is connected to the label portion 10 at a side edge 102 of the label portion 10. The side edge 102 extends between the label surface 100 and the rear side 101 of the label portion 10. In the present case, the film hinge 14 is connected to the label portion 10 at a longitudinal end thereof, specifically the longitudinal end further spaced from the locking device 11A.

The film hinge 14 is formed by a tapered region. Due to the taper, the film hinge 14 can be (manually) plastically and/or elastically deformed. By means of the film hinge 14, the holding bracket 12A can be pivoted relative to the label portion 10. The film hinge 14 and the holding bracket 12A are narrower than the label portion 10. The holding bracket 12A and the label portion 10 have a greater thickness than the film hinge 14. In the example shown, the holding bracket 12A has the same thickness as the label portion 10 (in a direction perpendicular to the plane of the label surface 100). The holding bracket 12A is designed in the form of an elongated strip. The length of the holding bracket 12A corresponds to the distance from the side edge 102 of the label portion 10 at the film hinge 14 to the rear wall 116 of the locking device 11A.

The locking portion 13A of the holding bracket 12A is formed at one end of the holding bracket 12A, in this case at the longitudinal end that faces away from the label portion 10. The locking portion 13A of the holding bracket 12A is hook-shaped. Specifically, the locking portion 13A has a recess 130 and a hook 131 formed by the recess 130. The recess 130 is formed in a side edge 120 of the holding bracket 12A. The side edge 120 connects an upper side 121 to an underside 122 of the holding bracket 12A. In this case, the upper side 121 runs parallel to the underside 122. In the configuration according to FIGS. 2A and 2B, the upper side 121 of the holding bracket 12A is arranged on the same side of the labeling plate 1A as the label surface 100 of the label portion 100. The same applies to the underside 122 and the rear side 101. The recess 130 extends from the upper side 121 to the underside 122 through the holding bracket 12A. The recess 130 is formed only on the one side edge 120 of the holding bracket 12A, not on the opposite side edge.

In the configuration shown in FIGS. 2A and 2B, the label portion 10 and the holding bracket 12A are arranged in one plane. This configuration can also be called the initial configuration. In the initial configuration, the film hinge 14 is relaxed. The upper side 121 of the holding bracket 12A and the label surface 100 of the label portion 10 extend in the same plane. The holding bracket 12A can be pivoted relative to the label portion 10 by means of the film hinge 14, i.e., can be arranged in one plane and pivoted in planes inclined to one another.

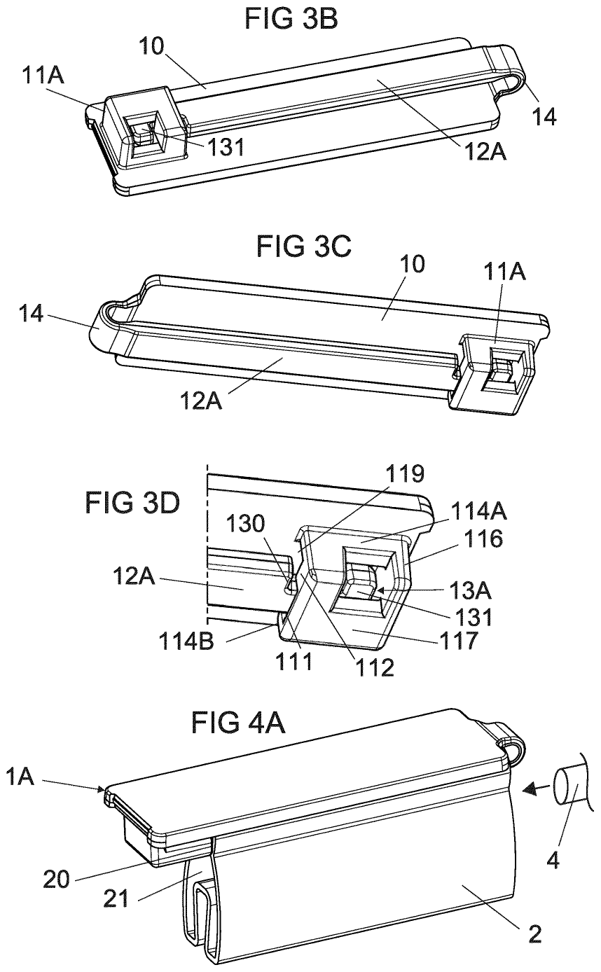

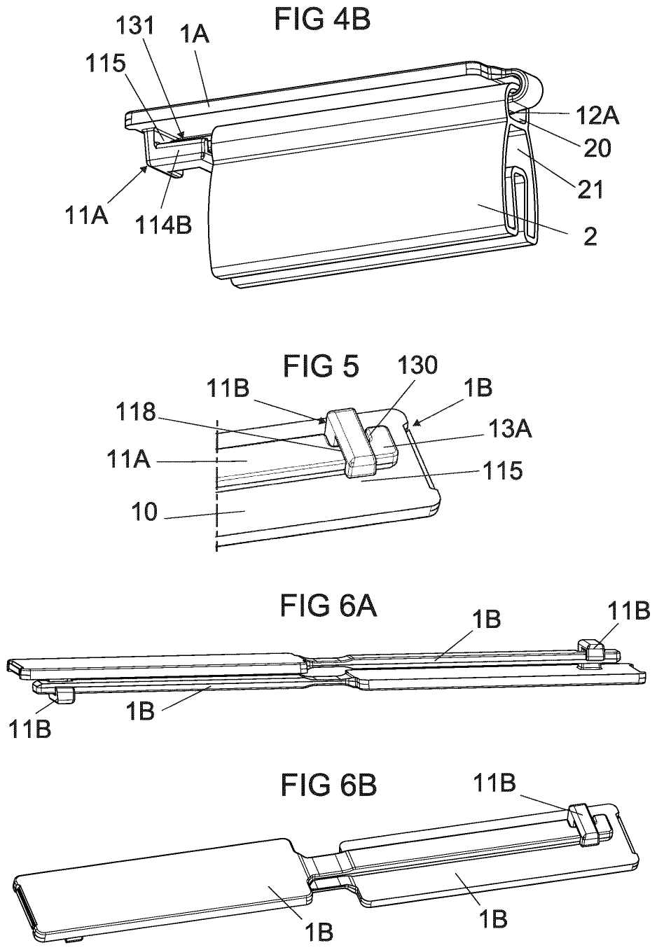

Thus, the inscribable label 1A can be transferred from the initial configuration into a locked configuration shown in FIG. 3A to 3D. In the locked configuration, the locking portion 13A is locked to the locking device 11A. Here, the hook 131 of the locking portion 13A is inserted into the pocket 110 of the locking device 11A. In the locked configuration, the film hinge 14 is bent, in this case by 180 degrees. In the locked configuration, the holding bracket 12A extends along the label portion 10 (and in this case also parallel thereto). A clearance is formed between the label portion 10 and the holding bracket 12A, which clearance allows a portion of a cable grommet 2 shown in FIGS. 4A and 4B to extend therebetween.

In order to lock with the locking device 11A, it is possible, on the one hand, to insert the locking portion 13A frontally into the opening 119 of the pocket 110, in this case in a direction parallel to the longitudinal extension of the holding bracket 12A. The holding bracket 12A then enters the pocket 110 with its longitudinal end first. In this case, the opening 119 is L-shaped. By means of a block 112 of the locking device 11A, the opening 119 has a recess 111 at which the opening 119 has a smaller width than in an region above it. Thus, the locking portion 13A can be inserted into the pocket 110 in an engagement direction (in this case parallel to the longitudinal extent of the holding bracket 12A) through the wider region of the opening 119 and then moved into the recess 111 in a locking direction perpendicular thereto. In this case, the hook 131 locks with the locking device 11A, here specifically with the block 112. The window 113 allows for a visual inspection of the locking mechanism. In addition, the window 113 allows for demolding by means of sliders during the injection molding process.

As can be seen in particular from FIG. 4B, the locking device 11A has a lateral engagement 115. In the present case, the engagement 115 is formed in one side wall 114B of the locking device 11A. The engagement 115 forms a slot between the side wall 114B and the (flat) rear side 101 of the label portion 10. The engagement extends over the entire length of the side wall 114. Specifically, the engagement 115 extends to the rear wall 116 and is open to the side of the locking device 11A facing away from the rear wall 116. Thus, the holding bracket 12A can also be inserted into the pocket 110 from the side instead of from the front, i.e., by a pivoting movement within a plane parallel to the label surface 100. In this case, the engagement direction of the locking portion 13A runs parallel to the label surface 100 and perpendicular to the longitudinal extension of the holding bracket 12A. The locking direction is in turn aligned perpendicular to the label surface 100, as described above.

In order to lock with the cable grommet 2 shown in FIGS. 4A and 4B, the holding bracket 12A is first pushed through a bracket feed-through 20 of the cable grommet 2 until the locking portion reappears at the other end of the bracket feed-through 20. The label portion 10 bent before, during or after this is then locked to the locking portion 13A by means of the locking device 11A. The film hinge 14 is then bent. The locking portion 13A is held in the locking position in the locking device 11A by elastic tension of the film hinge 14. Furthermore, the material of the cable grommet 2 prevents unintentional opening.

When locked, the holding bracket 12A is protected against both lateral forces and tensile forces.

The cable grommet 2 further comprises a cable feed-through 21 through which a cable 4 can be inserted (before or after the installation of the inscribable label 1A). This allows for easy-to-attach, relatively large and clearly visible labeling of the cable 4.

Together, the inscribable label 1A and the cable grommet 2 form an inscribable label set.

FIG. 5 shows a label 1B that is designed like the inscribable label 1A described above and, in comparison, only has a differently designed locking device 11B. According to FIG. 5, the locking device 11B is hook-shaped. The locking device 11B is U-shaped, one leg of the U being connected to the label portion 10 and the other leg of the U being spaced from the label portion 10.

The locking device 11B has a recess 118 that forms the hook shape, it being possible for the locking portion 13B to be locked to the locking device 11B in such a way that the recesses 130, 118 of the locking portion 13A and the locking device 11B are aligned perpendicular to one another.

For locking, the locking portion 13A can be swung in laterally and then engage in a locking manner in the recess 118 in a direction perpendicular thereto (in a direction perpendicular to the label surface 100).

While the design of the inscribable label 1A according to FIG. 2A-4B allows for a particularly secure lock, the design according to FIG. 5 is particularly easy to manufacture.

FIGS. 6A and 6B show two inscribable labels 1B that are locked together on both locking devices 11B, primarily for illustrative purposes. Optionally, other components can also be inscribed in this way. Furthermore, the inscribable labels 1B can be transported in this way. In addition, the figures illustrate the interaction of the holding bracket 11A and the locking device 11B during locking.

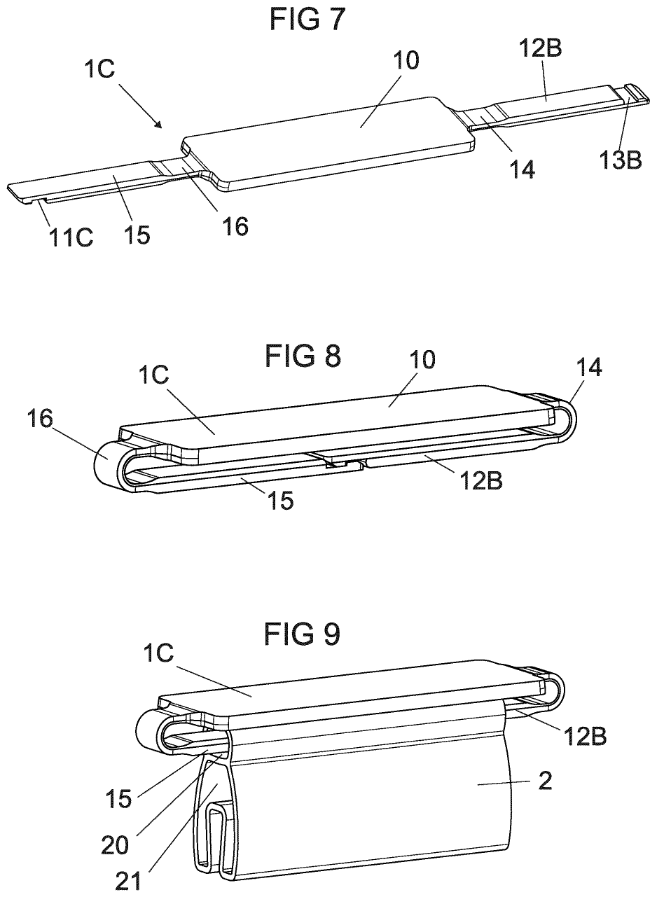

According to FIGS. 7 and 8, in an inscribable label 1C, it can be provided that a locking device 11C is formed on a further holding bracket 15 that is connected to the label portion 10 so as to be movable relative to the label portion 10 via a further film hinge 16. This locking device 11C is therefore not formed directly on the label portion 10, but is connected thereto via the further holding bracket 15 and the further film hinge 16.

The holding bracket 12B and the further holding bracket 15 are of the same design, but are oriented in opposite directions. The locking portion 13B of the holding bracket 12B and the locking device 11C of the further holding bracket 15 are both hook-shaped, in this case likewise of the same design (only oriented the other way around). In this case, a recess is not formed laterally, but in the upper side of the holding bracket 12B and in the underside of the further holding bracket 15.

The holding bracket 12B and the further holding bracket 15 are connected to the label portion 10 on opposite sides of the label portion 10.

For locking, both holding brackets 12B, 15 can be folded down by means of the film hinges 14, 16, so that the locking portion 13B and the locking device 11C can lock together, see in particular FIG. 8.

Upon connection to the cable grommet 2, see FIG. 9, locking takes place within the bracket feed-through 20. To facilitate this, the locking portion 13B and the locking device 11C have lead-in chamfers at the ends. The inscribable label 1C, and optionally also the cable grommet 2, has/have an elasticity that allows insertion and locking.

The inscribable label 1C is particularly easy to manufacture using injection molding without a slider.

The label sheet 2 can of course alternatively or in addition to the inscribable labels 1A according to FIG. 2A to 4B also have one, a plurality of or only inscribable labels 1B and/or 1C according to FIG. 5 to 9.

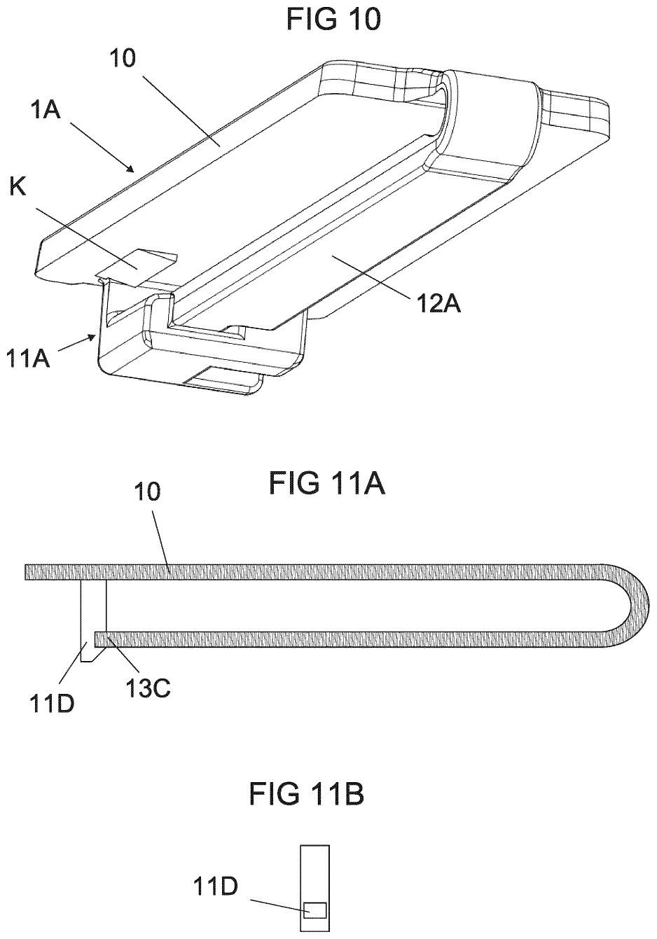

FIG. 10 illustrates, using the example of the inscribable label 1A shown in FIG. 2A, an additional securing element that can also be provided in any of the other inscribable labels described herein.

The securing element is designed to secure the locking portion 13A of the holding bracket 12A in the locking device 11A. The securing element allows the locking portion 13A to be inserted into engagement with and/or into the locking device 11A and prevents the locking portion 13A from moving out of the locking device 11A. In the example shown, the securing element is designed in the form of a safety pawl K. The safety pawl K has a lead-in chamfer into the locking device 11A. Furthermore, the safety pawl K has a latching edge against which the locking portion 13A located in the locking device 11A strikes.

FIG. 11A-14 show further examples of inscribable labels, a locking portion 13C-13E being (captively) secured on a locking device 11D-11G against unwanted release in at least two mutually perpendicular directions.

According to FIG. 11A, the locking device 11D has a receptacle and a lead-in chamfer leading to the receptacle. The locking portion 13C of the holding bracket is formed by the free end of the holding bracket. Said free end can be guided into the receptacle through the lead-in chamfer. In the receptacle, the locking portion 13C is secured in all lateral directions with respect to its longitudinal extension. The receptacle shown in plan view in FIG. 11B has a bottom and four side walls.

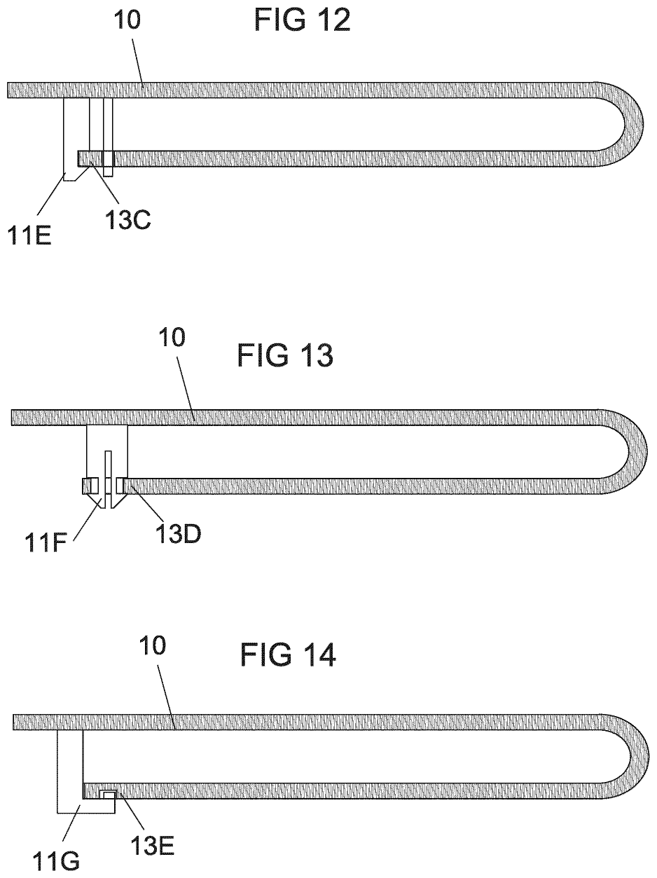

According to FIG. 12, the locking device 11E likewise has a receptacle. Said receptacle can be open in one or two lateral directions, but secures the locking portion 13C in both directions perpendicular to the label portion 10. An optional, separate stop prevents removal of the locking portion 13C in one or both lateral directions in which the receptacle is open.

According to FIG. 13, the locking device 11F has spring-elastic latching arms. In this case, the latching arms each have a lead-in chamfer and a latching edge. A slot is provided between the latching arms. The locking portion 13D comprises an opening that can be snapped onto the latching arms. Alternatively, for example, only one such latching arm is provided.

According to FIG. 14, the locking device 11G is L-shaped. The locking device 11G has a projection directed toward the label portion 10. The locking portion has a depression. The depression can be placed on the projection and is secured there in five mutually perpendicular directions.

The idea underlying the invention is not limited to the exemplary embodiments described above but can in principle also be realized in a completely different manner.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1A-1C Inscribable label
10 Label portion
100 Label surface
101 Rear side
102 Side edge
11A-11G Locking device
110 Pocket
111 Depression
112 Block
113 Window
114A, 114B Side wall
115 Engagement
116 Rear wall
117 Bottom
118 Recess
119 Opening
12A; 12B Holding bracket
120 Side edge
121 Upper side
122 Underside
13A-13E Locking portion
130 Recess
131 Hook
14 Film hinge
15 Holding bracket
16 Film hinge
2 Cable grommet
20 Bracket feed-through
21 Cable feed-through
3 Label sheet
30 Side web
31 Transverse web
32 Predetermined breaking point
4 Cable
K Safety pawl

1: An inscribable label for attachment to a cable grommet, the inscribable label comprising:
a label portion with an inscribable label surface;
locking device connected to the label portion; and
holding bracket,
wherein
a locking portion is formed on the holding bracket, the locking portion being configured for locking with the locking device.

2: The inscribable label to claim 1, wherein the holding bracket is connected to the label portion so as to be movable relative to the label portion.

3: The inscribable label to claim 2, wherein the holding bracket is connected to the label portion via a film hinge so as to be movable relative to the label portion.

4: The inscribable label of claim 3, wherein the film hinge is connected to the label portion at a side edge of the label portion, which side edge is short, relative to a further side edge.

5: The inscribable label of claim 1, wherein the label portion and the holding bracket are arranged so to be movable relative to one another such that the label portion and the holding bracket are arrangeable in a plane.

6: The inscribable label of claim 1, wherein the locking portion of the holding bracket has a recess that is hook-shaped or comprises an eyelet.

7: The inscribable label of claim 1, wherein the locking device has a pocket into which the locking portion is insertable.

8: The inscribable label of claim 7, wherein the pocket has an L-shaped or T-shaped opening.

9: The inscribable label of claim 1, wherein the locking device has two or three side walls, that are connected to one another by a bottom.

10: The inscribable label of claim 1, wherein the locking device is formed on a rear side of the label portion opposite the label surface

11: The inscribable label of claim 1, wherein the locking portion of the holding bracket is insertable into the locking device along an engagement direction and is lockable in the locking device with the locking device in a locking direction perpendicular to the engagement direction.

12: The inscribable label of claim 11, wherein the label portion is elongated and has a longitudinal extension direction, the engagement direction being aligned parallel or perpendicular to the longitudinal extension direction.

13: The inscribable label of claim 1, wherein the holding bracket is elongated, and cylindrical, and
wherein the locking portion of the holding bracket has a lateral recess.

14: The inscribable label of claim 13, wherein the locking device has a recess, the locking portion being lockable with the locking device such that the recess and the lateral recess engage with one another and are aligned perpendicular to one another.

15: The inscribable label of claim 1, wherein the locking device is formed on a further holding bracket that is connected to the label portion so as to be movable relative to the label portion via a film hinge.

16: The inscribable label of claim 15, wherein the holding bracket and the further holding bracket are connected to the label portion on opposite sides of the label portion.

17: The inscribable label of claim 1, wherein the locking device is hook-shaped.

18: The inscribable label of claim 1, wherein the holding bracket and the label portion are connected to one another in a cohesively bonded and/or integral manner, comprising a materially monolithic manner.

19: The inscribable label of claim 1, wherein the inscribable label comprises a polymer.

20: A label sheet, comprising:
a plurality of the inscribable label of claim 1,
wherein each inscribable label is removable without tools by being broken out.

21: An inscribable label set, comprising:
the inscribable label of claim 1; and
a cable grommet having a bracket feed-through for engagement by the holding bracket.

22: The inscribable label set of claim 21, wherein the grommet has a feed-through for passing a line.

23: A method, comprising:
labeling a cylindrical body with at least one of the inscribable label of claim 1,
wherein the cylindrical body comprises a hose or cable.
